(19) United States
(12) Patent Application Publication
(10) Pub. No.: US 2010/0020402 A1
(43) Pub. Date: Jan. 28, 2010

(54) MULTILAYER FILM

(75) Inventors: Masaaki Imura, Shiga (JP); Toshimasa Kanai, Shiga (JP); Koji Ikegami, Shiga (JP)

Correspondence Address: DRINKER BIDDLE & REATH (DC), 1500 K STREET, N.W., SUITE 1100, WASHINGTON, DC, 20005-1209, US

(73) Assignee: NIPPON ELECTRIC GLASS CO., LTD, Otsu-shi, Shiga (JP)

(21) Appl. No.: 12/439,383

(22) PCT Filed: Aug. 30, 2007
(86) PCT No.: PCT/JP2007/066932

§ 371 Date: Feb. 27, 2009

(30) Foreign Application Priority Data
Aug. 30, 2006 (JP) 2006-233214
Feb. 27, 2007 (JP) 2007-047523

(51) Int. Cl. G02B 1/11

(52) U.S. Cl. 359/601

(57) ABSTRACT

An object of the present invention is to provide a multilayer film that can make large the amount of outgoing light from a liquid crystal device such as liquid crystal display element and liquid crystal aberration compensating element and at the same time, can realize a high contract in a liquid crystal display element. The multilayer film of the present invention is a multilayer film which is formed on an inner side of a transparent substrate and contains a transparent electrically-conductive film and an orientation film, in which an antireflection film is provided at least either between the transparent substrate and the transparent electrically-conductive film or between the transparent electrically-conductive film and the orientation film.

### TECHNICAL FIELD

The present invention relates to a multilayer film suitably used for liquid crystal devices such as liquid crystal display devices or liquid crystal aberration compensating elements.

### BACKGROUND ART

As is well known, liquid crystal display devices include a direct viewing-type liquid crystal display used for a liquid crystal television, a cellular phone and the like, and a projection-type liquid crystal display device used for a projection television, a liquid crystal projector and the like.

The direct viewing-type liquid crystal display device contains a liquid crystal display element fabricated by forming various wirings or elements on a substrate such as sheet glass, laying two kinds of substrates to face each other, that is, a color filter substrate (hereinafter referred to as a “CF substrate”) having printed thereon R (red), G (green) and B (blue) dyes in a three-color array and a TFT array substrate (hereinafter referred to as a “TFT substrate”) having formed thereon TFT for controlling the liquid crystal, and enclosing a liquid crystal therebetween. Such liquid crystal display elements include a transmission type and a reflection type, and in the case of a transmission type, a light source unit (backlight) is disposed on the back surface of the liquid crystal display element, whereas in the case of a reflection type, a light source unit is not required and for reflecting the incident light, the TFT substrate surface is made to work as a reflecting surface. In either case, the CF substrate uses a transparent electrically-conductive film such as ITO as the electrode so as to transmit light. Furthermore, in order for preventing liquid crystals from being disorderly disposed to deteriorate the image quality, an orientation film such as organic resin film or silicon oxide film is formed on a surface of the CF substrate or TFT substrate which comes into contact with the liquid crystal, and the orientation film of the CF substrate or the orientation film of the TFT substrate of a transmission-type liquid crystal element is formed of a transparent material so as to transmit light.

The projection-type liquid crystal display device usually contains three liquid crystal display elements, dichroic mirrors, a light source unit and a prism. A light emitted from the light source unit is split into light's three primary colors by dichroic mirrors, and these colors pass through respective liquid crystal display elements, then combined by a prism and projected on a screen.

As for the liquid crystal display element used in the projection-type liquid crystal display device, a reflection-type liquid crystal display element called LCOS (Liquid Crystal On Silicon, see, for example, Patent Document 1) or a transmission-type liquid crystal display element called HTPS (High Temperature Poly-Silicon) is attracting attention because of their high display image quality and high possibility of low-cost production.

As illustrated in FIG. 6, LCOS 20 has a structure where a silicon substrate 13 having thereon a reflection electrode 11 disposed in a matrix manner and a transistor driving circuit 12 for supplying a voltage to the electrode and a transparent substrate 16 having formed thereon a transparent electrode 14 and an antireflection film 15 are stacked to face each other through a spacer 17 and a liquid crystal layer 18 is provided in the gap formed by the spacer 17.

Further, as is well known, a liquid crystal aberration compensating element is used for an optical pickup device or the like and, as illustrated in FIG. 7, the liquid crystal aberration compensating element 30 has a structure where two sheets of transparent glass substrates G and G each having formed on one surface thereof a transparent electrode (ITO film) 21 and an orientation film 22 are stacked together to face each other through a spacer 23 and a liquid crystal layer 24 is provided in the gap formed by the spacer 23 (see, for example, Patent Document 2).

Patent Document 1: unexamined published Japanese patent application: JP-A-2002-296568

Patent Document 2: unexamined published Japanese patent application: JP-A-2001-100174

### DISCLOSURE OF THE INVENTION

### Problems that the Invention is to Solve

Incidentally, one of important problems in recent years is to show a projected image or a screen as bright as possible for the liquid crystal display device or to increase the transmittance for the liquid crystal aberration compensating element.

An increase in the amount of outgoing light from the liquid crystal display element is a theme more important for a projection-type liquid crystal display device displaying an enlarged and projected image than for a direct viewing-type liquid crystal display device. In combination with this, increasing the contrast is also an important theme.

As for the measure for increasing the amount of outgoing light from the liquid crystal display element and for increasing the contrast, in the reflection-type liquid crystal display element 20 described in Patent Document 1, as illustrated in FIG. 6, the antireflection film 15 is formed on the outer surface 16a (the surface which is not in contact with the liquid crystal layer 18) of the transparent substrate 16, whereby the reflection of incident or outgoing light is suppressed and the amount of outgoing light and the contrast are ensured. However, a sufficient amount of outgoing light and a high contrast have not been obtained yet.

Also, in the liquid crystal aberration compensating element of Patent Document 2, great reflection occurs between the glass substrate and the ITO film or between the ITO film and the orientation film, and this gives rise to a problem that the transmittance decreases.

The present invention has been made in view of these circumstances and an object of the present invention is to provide a multilayer film that can make large the amount of outgoing light from a liquid crystal device such as liquid crystal display element and liquid crystal aberration compensating element and, at the same time, can realize a high contract in a liquid crystal display element.

### Means for Solving the Problems

The multilayer film of the present invention, which has been devised for attaining the object above, is a multilayer film which is formed on an inner side of a transparent substrate (for example, when applied to a liquid crystal display element or a liquid crystal aberration compensating element, the side having a liquid crystal layer) and contains a transparent electrically-conductive film and an orientation film, in which an antireflection film is formed at least either between the transparent substrate and the transparent electrically-conductive film or between the transparent electrically-conductive film and the orientation film.

That is, since the present invention has the above-described construction, reflection of visible light on the inner surface of a transparent substrate of a liquid crystal display element, a liquid crystal aberration compensating element or the like can be suppressed. For example, in this case, the maximum reflectance at 400 to 700 nm can be suppressed to 2% or less. When this multilayer film is applied to a liquid crystal device such as liquid crystal display element (e.g., HTPS, LCOS) or liquid crystal aberration compensating element, reflection on both surfaces of a transparent substrate is reduced, so that the amount of outgoing light of a liquid crystal display element, a liquid crystal aberration compensating element or the like can be increased and the contrast of a liquid crystal display element can be made high.

In the construction above, an antireflection film is preferably provided both between the transparent substrate and the transparent electrically-conductive film and between the transparent electrically-conductive film and the orientation film. In this case, reflection of visible light on the inner surface of the transparent substrate can be more successfully suppressed. In particular, in the case where low resistance electrical conductivity is required as in HTPS and a transparent electrically-conductive film having a geometric thickness of 50 to 200 nm is therefore provided, it is preferable to form the antireflection film both between the transparent substrate and the transparent electrically-conductive film and between the transparent electrically-conductive film and the orientation film, because the effect of suppressing reflection of visible light on the inner surface of the transparent substrate can be increased.

In the construction above, the antireflection film is preferably a stacked film of a low refractive index layer and a high refractive index layer. The low refractive index layer is suitably formed of a material having a refractive index of 1.6 or less, such as SiO₂ or fluoride (e.g., MgF₂), and the high refractive index layer is suitably formed of a material having a refractive index of 2.0 or more, such as Nb₂O₅, TiO₂, Ta₂O₅, HfO₂ and ZrO₂.

In the case where a stacked film of a low refractive index layer and a high refractive index layer is formed as the antireflection film both between the transparent substrate and the transparent electrically-conductive film and between the transparent electrically-conductive film and the orientation film, the maximum reflectance at 400 to 700 nm can be suppressed to 0.25% or less.

Furthermore, in the construction above, the antireflection film between the orientation film and the transparent electrically-conductive film preferably has a geometric thickness of 10 to 100 nm. In this case, when a voltage is applied between the transparent electrically-conductive film (transparent electrode) and the opposing electrode (a reflection electrode in the case of a reflection-type liquid crystal display element, or a transparent electrode in the case of a transmission-type liquid crystal display element), the voltage (electric field) to be applied to the liquid crystal portion scarcely decreases.

However, in the case of a liquid aberration compensating element, it is preferred to form no antireflection film between the orientation film and the transparent electrically-conductive film. This is because, in the case of a liquid crystal aberration compensating element, the transparent electrically-conductive film needs to be concentrically patterned, so that for forming an antireflection film also between the transparent electrically-conductive film and the orientation film, the element needs to be once transferred from the film-forming step to the patterning step to effect patterning and then returned again to the film-forming step.

Accordingly, the antireflection film between the transparent substrate and the transparent electrically-conductive film is preferably formed to be composed of a stacked film of three or more layers, more preferably four or more layers, because the maximum reflectance can be made low without forming an antireflection film between the transparent electrically-conductive film and the orientation film.

In the construction above, the transparent electrically-conductive film preferably has a geometric thickness of 10 to 200 nm. In this case, the sheet resistance does not become low and, at the same time, the visible light transmittance can be kept high. That is, if the geometric thickness is less than 10 nm, the sheet resistance becomes excessively high, whereas if the geometric thickness exceeds 200 nm, the visible light transmittance decreases, both of which are not preferred. Also, in the case where low resistance electrical conductivity is required as in HTPS, the geometric thickness of the transparent electrically-conductive film is preferably from 50 to 200 nm, but in the case where light transmittance is more important than the low resistance of the transparent electrically-conductive film as in LCOS or liquid crystal aberration compensating element, the geometric thickness of the transparent electrically-conductive film is more preferably from 10 to 20 nm. This is preferred because the visible light transmittance on the short wavelength side does not become decreased. In particular, in the case of a liquid crystal aberration compensating element used in an optical pickup device, the element can advantageously respond to three wavelengths including BD (Blue Laser Disc, wavelength used: 405 nm), CD (Compact Disc, wavelength used: 780 nm) and DVD (Digital Versatile Disc, wavelength used: 658 nm). As the transparent electrically-conductive film, an ITO film, an AZO film, a GZO film and the like are suitably used.

In the construction above, examples of the transparent substrate which can be used include a glass substrate and a plastic substrate, and in view of environmental resistance, heat resistance, light resistance and the like, a glass substrate is preferred.

### ADVANTAGE OF THE INVENTION

The multilayer film of the present invention can suppress reflection of visible light on the inner surface of a transparent substrate. When the multilayer film is applied to a liquid crystal device such as liquid crystal display element (e.g., HTPS, LCOS) or liquid crystal aberration compensating element, reflection is reduced on both surfaces of a transparent substrate and therefore, the liquid crystal display element can be assured of a large amount of outgoing light and a high contrast.

### BRIEF DESCRIPTION OF THE DRAWINGS

FIG. 1 is an explanatory view illustrating the construction of the multilayer film according to Examples 1, 6 and 7 of the present invention.

FIG. 2 is an explanatory view illustrating the construction of the multilayer film according to Examples 2 to 5 of the present invention.

FIG. 3 is a graph illustrating the reflectance characteristics in Examples 1 and 2 of the present invention and Comparative Example.

FIG. 4 is a graph illustrating the reflectance characteristics in Examples 3 to 7 of the present invention.

FIG. 5 is an explanatory view of a liquid crystal aberration compensating element using the multilayer film in Examples of the present invention.

FIG. 6 is an explanatory view illustrating the structure of an LCOS element.

FIG. 7 is an explanatory view illustrating the structure of a conventional liquid crystal aberration compensating element.

### DESCRIPTION OF REFERENCE NUMERALS AND SIGNS

G Glass substrate
1 Transparent electrically-conductive film
2 Orientation film
3 First antireflection film
4 Second antireflection film
5 Liquid crystal aberration compensating element
6 Antireflection film responsive to three wavelengths
7 Spacer
8 Liquid crystal layer
10 Multilayer film

### BEST MODE FOR CARRYING OUT THE INVENTION

Working examples of the multilayer film of the present invention are described in detail below.

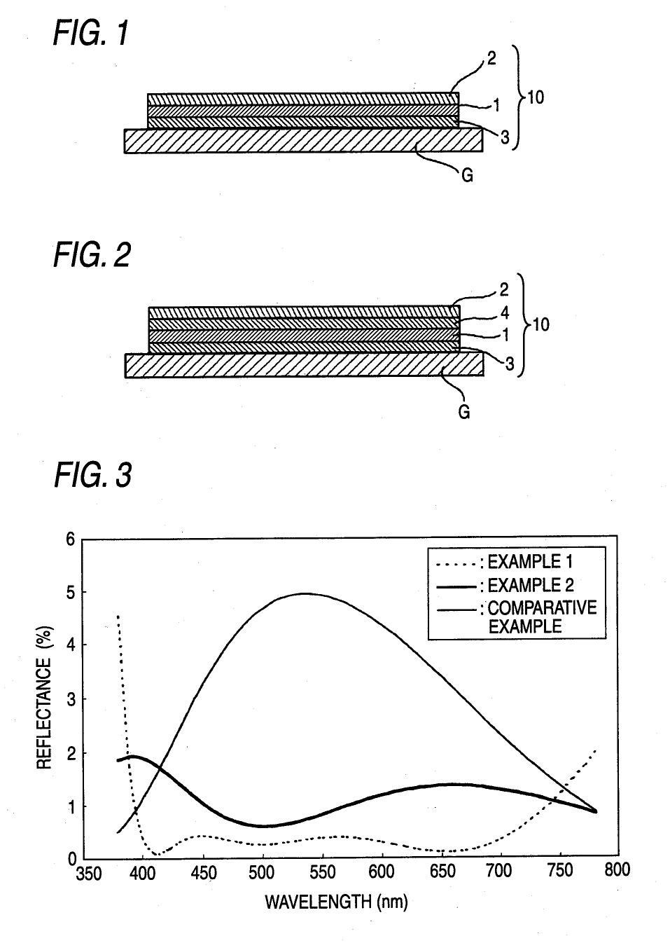

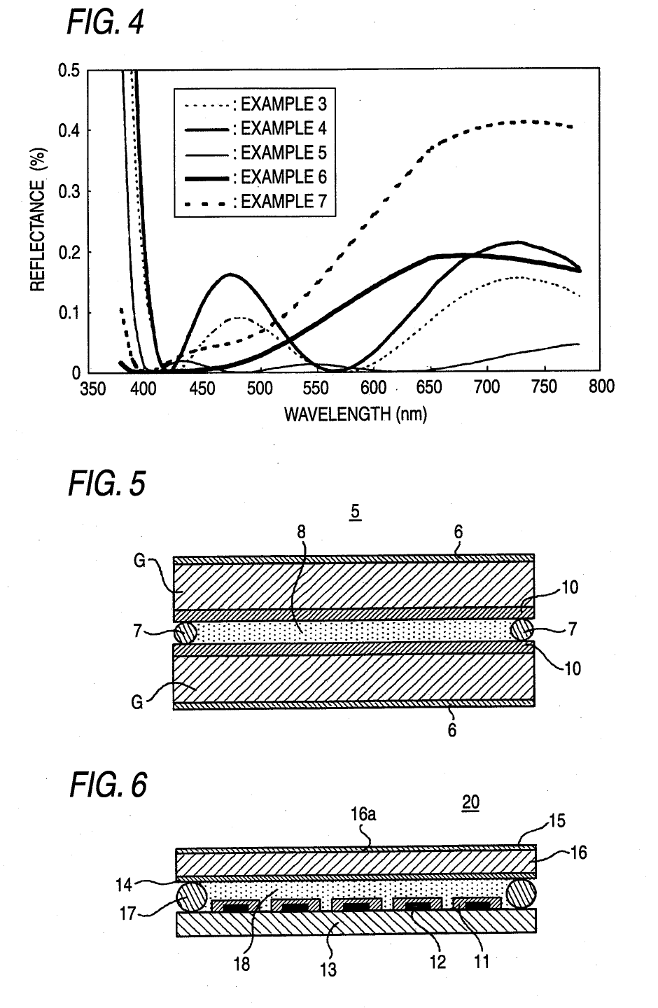

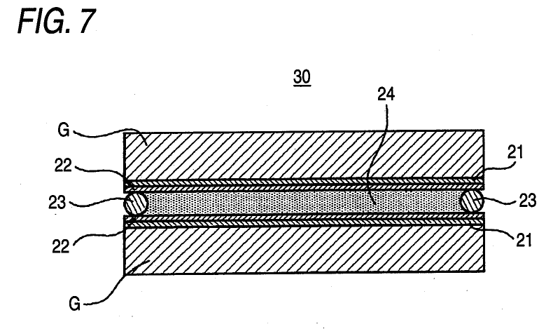

Table 1 shows Examples 1 to 5 of the present invention, and Table 2 shows Examples 6 and 7 of the present invention and Comparative Example. FIG. 1 is an explanatory view illustrating the construction of the multilayer film according to Examples 1, 6 and 7 of the present invention. FIG. 2 is an explanatory view illustrating the construction of the multilayer film according to Examples 2 to 5 of the present invention. FIG. 3 is a graph illustrating the reflectance characteristics in Examples 1 and 2 of the present invention and Comparative Example. FIG. 4 is a graph illustrating the reflectance characteristics in Examples 3 to 7 of the present invention. FIG. 5 is an explanatory view of a liquid crystal aberration compensating element using the multilayer film in Examples of the present invention.

TABLE 1

| | Example 1 | Example 2 | Example 3 | Example 4 | Example 5 |
|---|---|---|---|---|---|
| Transparent Substrate | Glass Substrate | | | | |
| First Layer | Nb₂O₅ (10 nm) | Nb₂O₅ (9 nm) | Nb₂O₅ (10 nm) | Nb₂O₅ (10 nm) | Nb₂O₅ (8 nm) |
| Second Layer | SiO₂ (50 nm) | SiO₂ (27 nm) | SiO₂ (32 nm) | SiO₂ (31 nm) | SiO₂ (35 nm) |
| Third Layer | Nb₂O₅ (29 nm) | ITO (80 nm) | ITO (80 nm) | ITO (80 nm) | ITO (80 nm) |
| Fourth Layer | SiO₂ (27 nm) | SiO₂ (7 mn) | SiO₂ (22 nm) | SiO₂ (19 nm) | SiO₂ (17 nm) |
| Fifth Layer | Nb₂O₅ (32 nm) | polyimide (50 nm) | Nb₂O₅ (13 nm) | Nb₂O₅ (11 nm) | Nb₂O₅ (17 nm) |
| Sixth Layer | ITO (80 nm) | — | SiO₂ (25 nm) | polyimide (50 nm) | SiO₂ (44 nm) |
| Seventh Layer | polyimide (50 nm) | — | polyimide (50 nm) | — | Nb₂O₅ (5 nm) |
| Eighth Layer | — | — | — | — | polyimide (50 nm) |
| Maximum Reflectance (%) | 0.42 | 1.88 | 0.16 | 0.21 | 0.02 |

TABLE 2

| | | | Comparative |
|---|---|---|---|
| Transparent | Example 6 | Example 7 | Example |
| Substrate | Glass Substrate | | |
| First Layer | Nb₂O₅ | Nb₂O₅ | ITO |
| | (4 nm) | (6 nm) | (80 nm) |
| Second Layer | SiO₂ | SiO₂ | Polyimide |
| | (55 nm) | (55 nm) | (50 nm) |
| Third Layer | Nb₂O₅ | Nb₂O₅ | — |
| | (11 nm) | (14 nm) | |
| Fourth Layer | SiO₂ | SiO₂ | — |
| | (46 nm) | (43 nm) | |
| Fifth Layer | ITO | ITO | — |
| | (12 nm) | (17 nm) | |
| Sixth Layer | polyimide | polyimide | — |
| | (50 nm) | (50 nm) | |
| Maximum | 0.19 | 0.41 | 5 |
| Reflectance (%) | | | |

As shown in Tables 1 and 2 and FIG. 1, in each of the multilayer films 10 of Examples 1, 6 and 7, a transparent electrically-conductive film 1 (refractive index 1.85; geometric thickness: 80 nm) composed of ITO and an orientation film 2 (refractive index: 1.6; geometric thickness: 50 nm) composed of a polyimide resin were provided on a glass substrate G (OA-10, produced by Nippon Electric Glass Co., Ltd.; refractive index: 1.47, thickness: 1.1 mm), and an antireflection film 3 (first antireflection film) was formed between the glass substrate G and the transparent electrically-conductive film 1. Also, as shown in Table 1 and FIG. 2, in each of multilayer films 10 of Examples 2 to 5, in addition to the first antireflection film 3, an antireflection film 4 (second antireflection film) was formed also between the transparent electrically-conductive film 1 and the orientation film 2. The antireflection films other than the second antireflection film of Example 2 (single-layer film of SiO₂) each contained a stacked film of a low refractive index layer (refractive index: 1.47) composed of SiO₂ and a high refractive index layer (refractive index: 2.34) composed of Nb₂O₅.

In Comparative Example, only a transparent electrically-conductive film and an orientation film were formed but an antireflection film was not formed (not illustrated).

FIG. 3 illustrates the visible light reflectance characteristics in Examples 1 and 2 and Comparative Example, and FIG. 4 illustrates the visible light reflectance characteristics in Examples 3 to 7. Incidentally, the visible light reflectance was determined by making light at a wavelength of 380 to 780 nm to be incident from the orientation film side (liquid crystal side) at an incident angle of 12°, and simulating the reflection characteristics on the assumption that a liquid crystal layer (refractive index: 1.6) was formed outside of the orientation film. Also, the maximum reflectance in Tables 1 and 2 is a maximum reflectance in the wavelength region of 400 to 700 nm.

As seen from Tables 1 and 2, in all of Examples 1 to 7 of the present invention, the maximum reflectance in the visible light region was as low as 2% or less, and above all, the maximum reflectance in Examples 3 to 6 was 0.25% or less and was particularly low. On the other hand, in Comparative Example, the maximum reflectance in the visible light region was as high as 5%.

Furthermore, the multilayer films in Examples above, particularly the multilayer films in Examples 6 and 7, are usable not only for LCOS or HTPS, but for a liquid crystal aberration compensating element 5 illustrated in FIG. 5. The liquid crystal aberration compensating element 5 has a structure where two sheets of transparent glass substrates G and G each having formed thereon the multilayer film 10 of Examples and an antireflection film 6 responsive to three wavelengths (405 nm, 658 nm, 780 nm) are stacked together through a spacer 7 and a liquid crystal layer 8 having a thickness of 10 μm is provided in the gap formed by the spacer 7. In the multilayer film 6 responsive to three wavelengths, oxide films of Nb₂O₅ (12 nm), SiO₂ (42 nm), Nb₂O₅ (26 nm), SiO₂ (21 nm), Nb₂O₅ (73 nm), SiO₂ (20 nm), Nb₂O₅ (22 nm) and SiO₂ (98 nm) are stacked in this order from the transparent glass substrate G side.

Reflection of transmitted light is suppressed by employing such a structure, so that even when transmitted light interferes inside of the liquid crystal layer (between multilayer films), high transmittance of transmitted light in the use wavelength region (400 to 800 nm) is obtained. In particular, even when an ITO film is used as the transparent electrically-conductive film, the transmittance of transmitted light in the short wavelength region (400 to 660 nm) can be kept high. Therefore, this liquid crystal aberration compensating element 30 is suitable for an optical pickup device not only of CD or DVD but also of BD.

### INDUSTRIAL APPLICABILITY

As described above, the multilayer film of the present invention is assured of a low reflectance and a sufficient large amount of outgoing light as well as high contrast and therefore, is suitable for a liquid crystal device such as transmission-type liquid crystal display element (e.g., HTPS or LCOS), reflection-type liquid crystal display element and liquid crystal aberration compensating element.

While the invention has been described in detail and with reference to specific embodiments thereof, it will be apparent to one skilled in the art that various changes and modifications can be made therein without departing from the spirit and scope thereof.

This application is based on Japanese Patent Application (Patent Application No. 2006-233214) filed on Aug. 30, 2006 and Japanese Patent Application (Patent Application No. 2007-047523) filed on Feb. 27, 2007, the entire contents of which are incorporated herein by way of reference. Furthermore, all references cited herein are incorporated by reference herein in their entirety.

1: A multilayer film which is formed on an inner side of a transparent substrate and comprises a transparent electrically-conductive film and an orientation film, wherein an antireflection film is provided at least either between the transparent substrate and the transparent electrically-conductive film or between the transparent electrically-conductive film and the orientation film.

2: The multilayer film according to claim 1, wherein the antireflection film is provided both between the transparent substrate and the transparent electrically-conductive film and between the transparent electrically-conductive film and the orientation film.

3: The multilayer film according to claim 1, wherein the antireflection film is a stacked film comprising a low refractive index layer and a high refractive index layer.

4: The multilayer film according to claim 1, wherein the antireflection film provided between the transparent electrically-conductive film and the orientation film has a geometric thickness of 10 to 100 nm.

5: The multilayer film according to claim 1, which has a maximum reflectance at 400 to 700 nm of 2% or less.

6: The multilayer film according to claim 1, wherein the transparent electrically-conductive film has a geometric thickness of 10 to 200 nm.

7: The multilayer film according to claim 2, wherein the antireflection film between the transparent electrically-conductive film and the orientation film is a stacked film comprising a low refractive index layer and a high refractive index layer.
